(19) United States
(12) Patent Application Publication
(10) Pub. No.: US 2008/0123265 A1
(43) Pub. Date: May 29, 2008

(54) Device for reproducing information for entertaining or data processing

(75) Inventor: Josef Ohlinger, Altmunster (AT)

Correspondence Address: FOLEY & LARDNER LLP, 777 EAST WISCONSIN AVENUE, MILWAUKEE, WI, 53202-5306, US

(73) Assignee: FUNWORLD AG

(21) Appl. No.: 11/519,456

(22) Filed: Sep. 12, 2006

(30) Foreign Application Priority Data
Sep. 14, 2005 (AT) GM 622/2005

(51) Int. Cl. G06F 1/16

(52) U.S. Cl. 361/681; 361/683

(57) ABSTRACT

A device for reproducing information includes an adjustable display unit, which is disposed on a vertical support column in a laterally projecting and height-adjustable manner via a horizontal arm that is connected to the support column and projects laterally therefrom, and an input device. The support column is mounted in a base housing and is adjustable in its height by means of a drive unit. The display unit is mounted directly on the horizontal support arm, which is firmly connected to the support column, so as to tilt about the axis of the arm.

This application claims priority to Austria Utility Model Application No. GM 622/2005 filed on Sep. 14, 2005, which is incorporated herein by reference in its entirety.

### FIELD OF THE INVENTION

The invention relates to a device for reproducing information, for entertaining and/or for data processing, comprising at least one adjustable display unit, which is disposed on a vertical support column in a laterally projecting and height-adjustable manner via a horizontal support arm that is connected to the support column and projects laterally thereof, and an input device.

### BACKGROUND OF THE INVENTION

From EP 1 111 571 A, a device is known, which is configured particularly as an entertainment device, for playing computer games, and which has a convex front side, in which also the display unit is integrated. Beneath the display unit, further devices are provided, such as a card reader, a coin insertion device and similar devices. This configuration means that this device and/or these input devices can only be operated while standing up, not however while sitting since the bottom part of the device would be in the way of the legs of a person sitting down. This is particularly disadvantageous when the device is configured as an entertainment device, for example as a gaming machine, for playing a computer game, etc., with the device being used and operated by a person for an extended period. It would be useful if the device could be operated and/or the reproduced information could be viewed while sitting in a chair or on a stool.

U.S. Pat. No. 5,630,566 A and U.S. Pat. No. 6,796,536 B refer to frame structures for computer devices, particularly a laptop, intended particularly for bedridden patients, wherein the display unit (as well as the keyboard) project laterally and are attached to a frame. According to U.S. Pat. No. 5,630,566 A, articulating arms are provided, which are provided on the frame so as to be adjustable in height; according to U.S. Pat. No. 6,796,536 A the support column of the frame can be extended telescope-like and is provided with an articulated arm via a horizontal support arm, which articulated arm in turn supports a console for a laptop. In both cases, space is available below the computer devices, allowing a bedridden person to work with a computer, for example. The known support devices, however, are relatively unstable and yet complicated.

The latter also applies to the workstation according to WO 01/15570 A in which a telescoping column is supported on the floor by three bases and carries a platform for a display unit via a laterally projecting swivel arm. This display unit in this configuration also cannot be tilted forward/backward about a horizontal axis, but only pivots about the vertical axes.

Finally, U.S. Pat. No. 6,098,936 A and U.S. Pat. No. 4,638,969 A are further designs with arrangements of display units on support arms that project laterally from a support column, wherein for example according to U.S. Pat. No. 4,638,969 A the forward and backward tilting of the display unit is possible with the help of an axis, which is fixed with screws in a U-shaped bracket; the U-shaped bracket is firmly connected to the horizontal support arm via a support; as a result, a complex, yet less stable design is created.

### SUMMARY OF THE INVENTION

The device according to a preferred embodiment of the invention is intended not only for use as a gaming or entertaining device, but also for reproducing information or for data processing purposes. Applications in public areas, at airports, in hotels or train stations, for example to retrieve arrival or departure information or times, to issue tickets, to reproduce information and the like are conceivable. Also its use as a music device or time recording device is conceivable. In general, the device should be of practical use wherever interaction between a user and the device is supposed to occur. Accordingly, the device may be provided with an intelligent system of its own, such as an integrated computer, or it may simply be configured as a terminal with a connection to a mainframe computer.

It is an intent of this device to ensure good operability and readability of information on the display unit without requiring gyrations on the part of the user. This problem is particularly important when configuring the device as an electronic entertainment device, as has been indicated above, however it is also relevant for other applications.

It is an object of the invention to configure a device of the kind mentioned above such that it allows optimal operability and retrieval of information by reading it on the display unit without twisting the body or head, while also allowing use of the device while sitting. Furthermore, it is also an object of the invention within the framework of this general objective to enable the display unit to be adjusted to different applications, so that it can not only be operated comfortably while sitting down, but also while standing up. Nevertheless, the design and assembly of the device should be as simple as possible, yet stable during operation, and the device should also have an appealing appearance.

The device of the kind mentioned above according to a preferred embodiment of the invention is characterized in that the support column is mounted in a base housing and adjustable in height by means of a drive unit, and in that the display unit is mounted directly on the horizontal support arm that is firmly connected to the support column so as to tilt about the axis of the arm.

Due to the fact that in an embodiment of the present device the display unit in the installed state is disposed laterally on an upright support column, sufficient space can be easily provided beneath the display unit, so that room is available for the legs of a person sitting in front of the display unit. The display unit itself can pivot about a horizontal axis, for example, which is a known per se configuration, in order to allow an adequate position of the screen relative to the user's head, depending on the size of the person operating the device, so that the user may read the reproduced information optimally, without reflections and without twisting his head. So as to achieve the unimpaired lateral projection of the display unit, the display unit is disposed on a horizontal support arm, which is connected to the vertical support column and projects laterally therefrom. The display unit is pivotably mounted directly on the support arm to achieve the pivoted adjustment.

This pivoted mount of the display unit on the support arm can be implemented particularly easily, wherein also a tight mount of a bearing part of the display unit on the cylindrical support arm or on a cylindrical bearing part of the support part may be provided, so that the display unit remains automatically fixed in the adjusted pivot position on the support arm as a result of the tight connection.

In addition to this pivot adjustment of the display unit, a height adjustment is provided, with the vertical support column being disposed such that it can be adjusted in its height; the support column is held in a base housing with its lower part, thus enabling a compact, stable configuration as well as self-contained, particularly mobile set-up of the device. The use of a base housing is particularly advantageous if the device, as has been mentioned above, is provided with an intelligent system of its own, since the base housing can accommodate the corresponding electronic units, as will be explained in more detail hereinafter.

A drive unit, comprising particularly a spindle drive, is provided for adjusting the height of the support column, allowing convenient handling. The drive unit is suitably implemented as an electric motor, which is associated with a corresponding control unit in order to move the support column up or down upon actuation of an “up” switch or “down” switch.

The drive unit, particularly an electric motor with spindle drive, can be configured as a self-contained, separate module and integrated in the base housing, thus allowing the module to be prefabricated and the finished module to be installed in the housing, which facilitates the installation of the device.

As has already been indicated above, the present device may be provided with corresponding devices for special applications, particularly as an entertainment or gaming device, and accordingly a computer unit, a money insertion unit with coin verification etc., as is already known, and similar devices, can be accommodated in the base housing. It is preferred if these units, particularly the computer unit and/or the money insertion unit or coin machine unit, are again configured as modules to allow simpler installation.

So as to produce a surface for placing different objects on top, such as written documents, books, but also drinking glasses, ash trays and the like, the base housing may comprise on its upper side a table top, which has an opening for the support column.

Additionally, to increase the stability of the device when it is set up, but also to create a foot rest surface, it is advantageous if the base housing is provided with a laterally projecting base plate on the bottom. It is particularly advantageous if the base plate comprises a foot rest that has been provided by means of bending (edging), for example.

So as to achieve easy displaceability of the device, it is also advantageous if the base housing has at least one rotatably seated roller or the like, preferably two rollers, at least on one bottom edge.

To ensure a particularly suitable shape of the input device in light of the laterally projecting arrangement of the display unit, it is advantageous if the display unit has a touch screen monitor; it would also be conceivable to provide the display unit with an integrated keyboard, however for many applications such a keyboard monitor is not required, particularly when configuring the device as an entertainment device or a gaming device. As a result, a particularly compact shape of the display unit is achieved when using a touch screen.

Furthermore, the display unit may comprise an integrated loudspeaker and/or an integrated imaging unit, particularly a video camera or webcam, and it may also be configured as a self-contained module with a corresponding controller as well as optionally with further components.

For easy, yet secure installation, the display unit may be secured on the support arm by means of a lock, thus preventing the unauthorized removal of the display unit, on the other hand, however, allowing easy removal and/or detachment of the display from the support arm upon actuation of the lock.

### BRIEF DESCRIPTION OF THE DRAWINGS

The invention will be explained in further detail hereinafter with reference to the embodiments that are schematically illustrated in the figures, however, without limiting the invention to these embodiments, wherein:

FIG. 1 is a schematic illustration of a device according to an exemplary embodiment of the invention, which is configured in this example as a gaming and/or entertainment device;

FIGS. 2 and 3 are front views of this device, the display unit of the device according to FIG. 2 being shown in the retracted state and that according to FIG. 3 in the telescoped state;

FIG. 4 is a front view of the device that is comparable to that according to FIG. 2, however the housing front wall has been removed;

FIGS. 5 and 6 are side views of the device with the display unit being retracted (FIG. 5) or telescoped (FIG. 6), with a side wall of the base housing of the device being removed for better illustration of the drive unit for the support column carrying the display unit; and

FIGS. 7 and 8 each show a sectional view along the line VII-VII according to FIG. 3 to illustrate the pivoted mount of the display unit on a horizontal support arm that is firmly connected to the support column, the display unit being shown in two different pivot positions.

### DESCRIPTION OF PREFERRED EMBODIMENTS

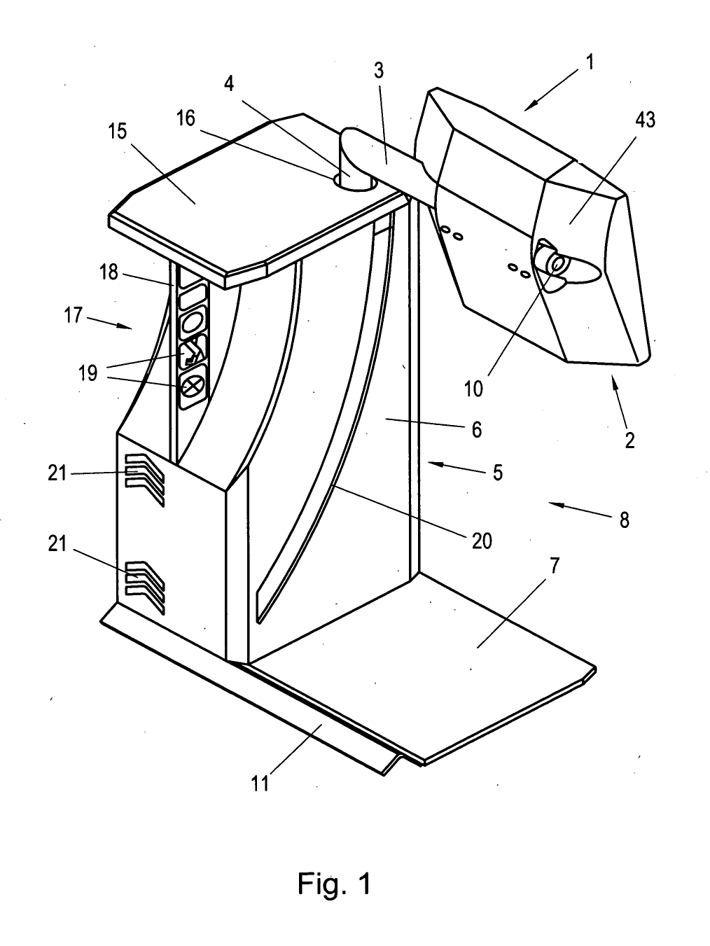

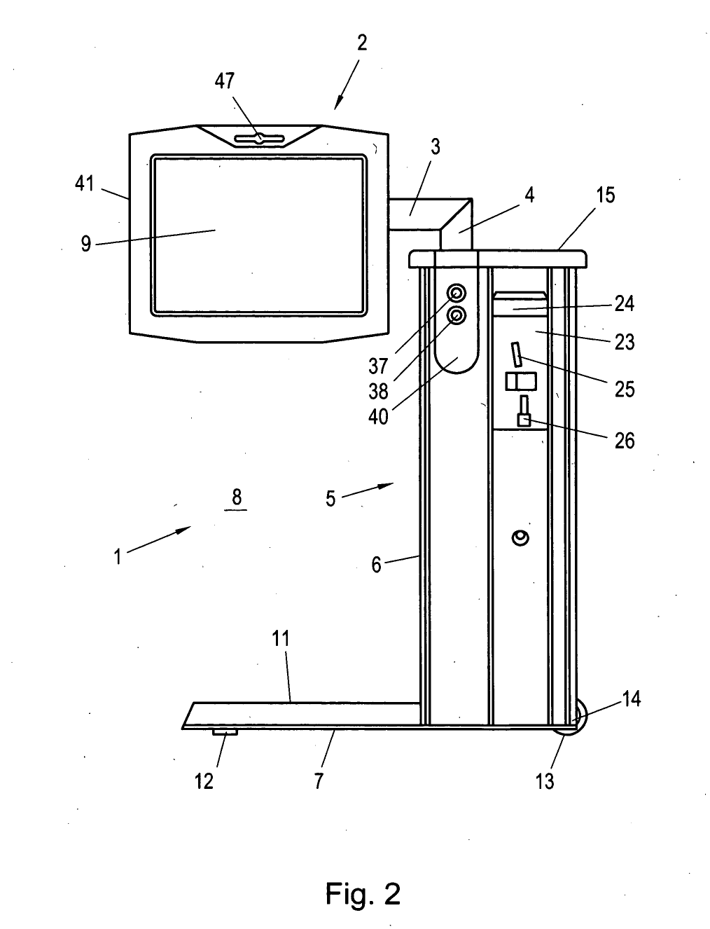

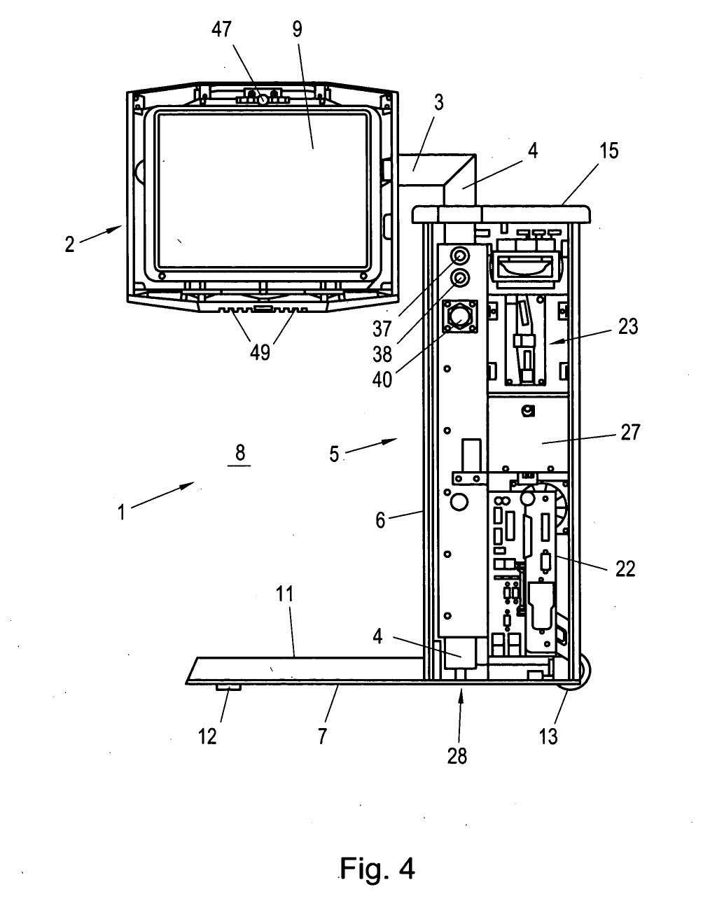

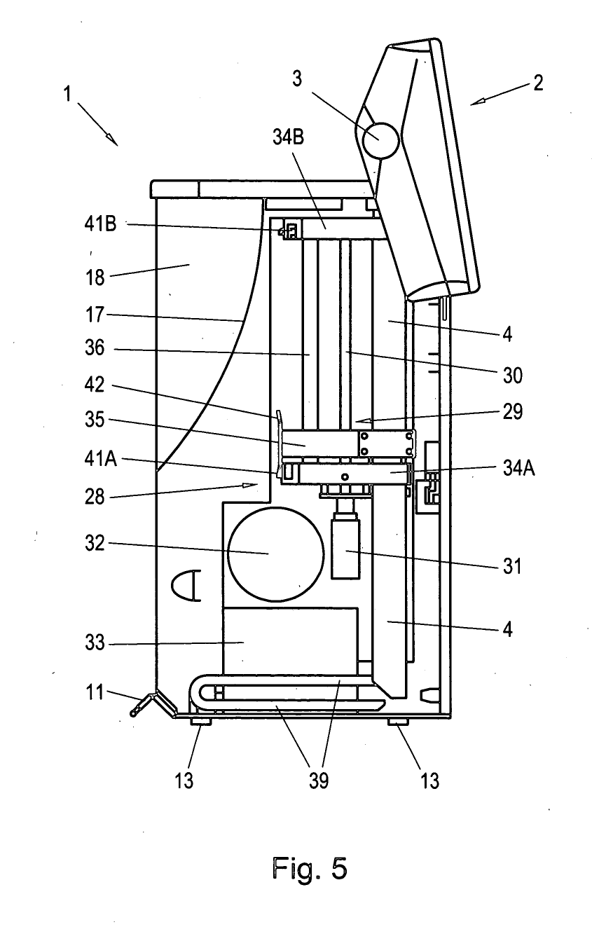

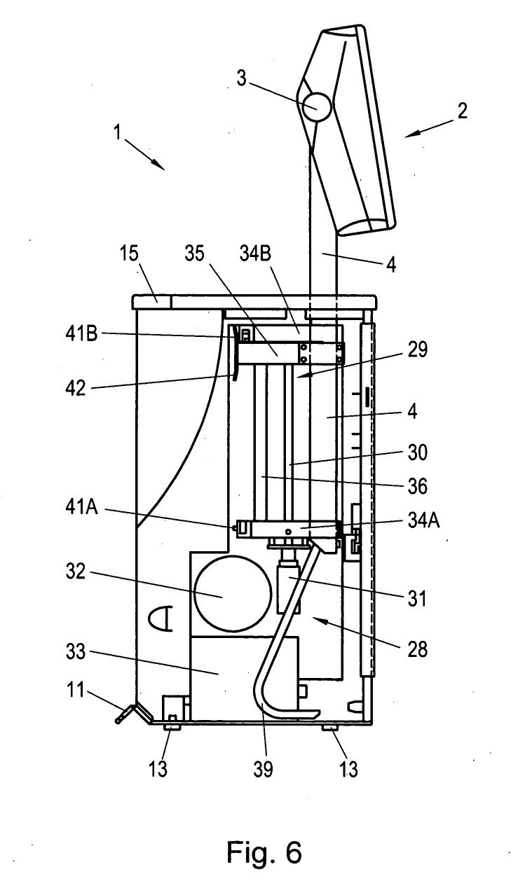

FIGS. 1-8 show a device 1 according to an exemplary embodiment of the invention. The device 1 is configured as a gaming or entertainment device and comprises a compact display unit 2, which is connected to a vertical support column 4 in an unimpaired projecting manner via a horizontal support arm 3. The support column 4 is disposed vertically displaceably in a base 5, which is configured as a base housing 6, as will be explained in more detail hereinafter in accordance with FIG. 4. The base housing 6 is intended to allow the device to be set up on the floor of a room, and a base plate 7 extends on the bottom away from the base housing 6, which plate provides the device 1 with additional stability when it is set up with the laterally projecting display unit 2 since the base plate 7 projects away from the base housing 6 on the same side as the display unit 2. As is apparent particularly in FIGS. 2 to 4, sufficient free space 8 is provided between the laterally projecting display unit 2 and the lower base plate 7, allowing a person that operates the device 1 to sit on a chair, stool or similar sitting furniture or even in a wheelchair in front of this device 1 without difficulty (according to the illustration in FIG. 5 or 6 to the right side of the device), wherein nevertheless a direct, straight view of the screen 9 of the display unit 2 is given. The screen and/or the monitor unit 9 of the display unit 2 is preferably configured as a touch screen monitor unit, so that direct input on the screen 9 is possible without a person sitting in front of the display unit 2 having to perform gyrations or turning the head.

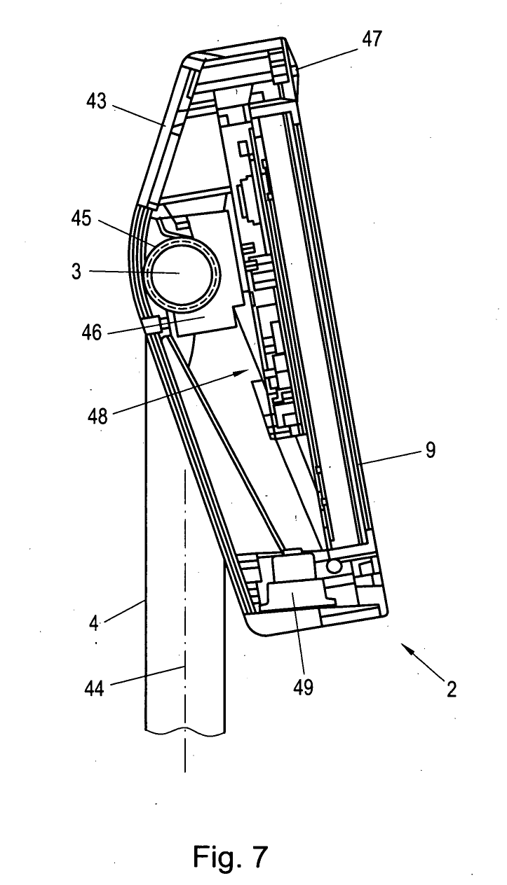

The display unit 2 is secured to the support arm 3 by means of a lock 10 (see FIG. 1), however it is easy to remove from the support arm 3 and also easy to mount to the support arm 3 again by sliding it on when the lock 10 has been unlocked, with the unit being secured following the installation with the lock 10. The pivoted mount of the display unit 2 on the support arm 3 will be explained in more detail hereinafter with reference to FIG. 7.

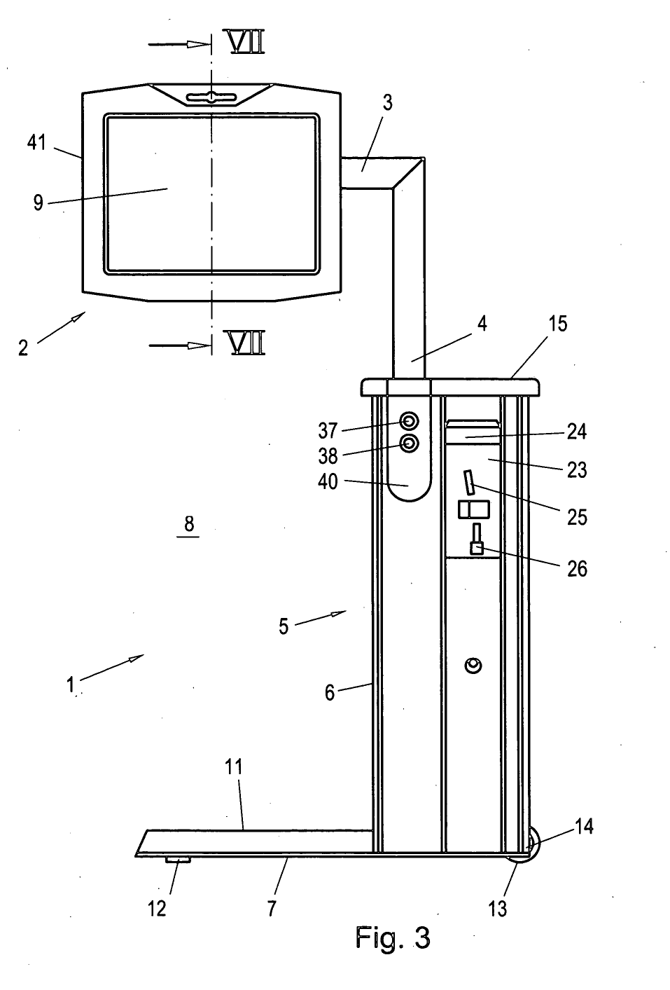

On its rear longitudinal edge, following the base housing 6, the base plate 7 has an angled edging to form the foot rest 11, see FIGS. 1 to 6. Furthermore, if it is not supposed to sit directly on the floor, the base plate 7 may have support feet 12, which may be configured, for example, as glued-on plastic parts. These feet 12, according to FIGS. 2 to 4, can keep the base plate 7 as well as the bottom of the base housing 6 at a distance from the floor, with this spacing being achieved not only by feet 12, but also by rollers 13, which are provided on the opposite side of the base housing 6, meaning the side facing away from the base plate 7, on the lower bottom edge 14 thereof (according to FIGS. 2 and 3). It is preferred if two such rollers 13 are provided, one each in a corner region 14 of the base housing 6, wherein these rollers 13 enable the clockwise displacement of the device 1 on the floor while tilting the base housing 6, as is illustrated according to FIG. 2 by the roller 13, to the right.

On its upper side, the base housing 6 comprises a table top 15, as is shown according to FIG. 1, which table top has an opening 16 for passing through the support column 4 of the display unit 2 in a sealed fashion (for example by means of a sealing lip, which is not shown in detail here) and additionally serves the purpose of creating a surface for placing documents or objects on top, such as drinking glasses, ash trays, books, written documents and the like. At the back of the device 1, the table top 15 protrudes beyond the base housing 6 with a taper 17, and beneath the table top 15 a vertical plate or strip 18 is provided in the free space created by the taper 17, which plate or strip is provided with illuminated flexible design elements 19, for example. Similarly, according to FIG. 1, for example an arched, illuminated design element 20 is provided on at least one side wall of the base housing 6.

At the back of the base housing 6, ventilation openings 21 are provided, as is shown according to FIG. 1, in order to allow air cooling of the modular computer unit or box 22 (which is shown only schematically in FIG. 4 and has a conventional design), which cooling is achieved by a fan, which is not shown in detail.

In light of the fact that the present device 1 has an intelligent system of its own due to its implementation as an entertainment device or gaming device, the computer unit 22 is provided in the base housing 6, as is a money insertion device 23, which is shown in FIGS. 2, 3 and 4 and which also has a modular design, and an insertion slot 24 for bills as well as a coin insertion slot 25 and a coin change slot 26 in the conventional manner. An electronic cash register 27 is disposed beneath this money insertion module 23, which register has a conventional design and in which the inserted money is collected, see FIG. 4.

Furthermore, according to FIGS. 5 and 6 (see also FIG. 4), an adjusting device, particularly a drive unit 28, is accommodated on the inside of the base housing 6, which device is also configured as a modular unit and is provided for adjusting the height of the support column 4 with the display unit 2. This drive unit 28 is configured, for example, with a spindle drive 29, wherein a threaded spindle 30 is driven by a motor 31, optionally by a gear mechanism that is installed in the motor housing, however which is not shown in detail in the drawing. The motor 31 is an electric motor, which is associated with a power supply unit 32 with a transformer and/or switched-mode power supply as well as a control unit 33. The motor 31 is provided on a lower bracket 34A, which is firmly arranged in the base housing 6 inside the modular drive unit 28, the spindle 30 extending through this bracket and the bracket rotatably seating the spindle. At the upper end, the spindle 30 is rotatably seated in a further, upper bracket 34B, which is firmly connected in the base housing 6. The spindle 30 furthermore extends through a threaded bore with a corresponding inside thread of a spindle nut block 35, which is firmly connected to the support column 4 configured as a tube. Moreover, the drive unit 28 comprises a guide rod 36 for guiding the spindle nut block 35 and the support column 4 during the up and down movements.

When the drive unit 28 is in operation, the motor 31 drives and rotates the spindle 30, and the spindle nut block 35 is moved up or down along the rotating spindle 30 as a result of the engagement of the thread. This vertical movement of the spindle nut block 35 is additionally guided by the guide rod 36. Together with the spindle nut block 35, the tube shaped support column 4 moves accordingly up or down, so that the desired height adjustment of the display unit 2 can be achieved with the support column 4 in a stable manner. It is provided, for example, that the display unit 2 can be displaced from a bottom position, which is shown according to FIGS. 1, 2 and 5, upward in height by 30 cm, with the uppermost position being shown in FIGS. 3 and 6.

So as to control the height adjustment, two control keys 37 (for example for the upward movement of the support column 4) and 38 (for the downward movement of the support column 4) are provided on the front of the base housing 6 in the upper region, adjacent to the space 8 for the sitting person, with these control keys 37, 38 being connected to the control unit 33 via electrical lines, which are not shown in detail in the drawings.

The hollow support column 4, which is configured as a pipe, accommodates on the inside thereof cables 39 for the power supply to the display unit 2. The cables 39 extend from the vertical support column 4 into the horizontal support arm 3, which is also configured as a tube, and from there to the corresponding connections in the display unit 2, wherein this electrical connection can be achieved in the conventional manner with sufficiently flexible cables and is therefore not shown in detail in the drawing.

Furthermore, in the region below the control keys 37, 38, a transponder system 40 is provided on the front of the base housing 6, see FIGS. 2, 3 and 4. This transponder system 40 is used to facilitate the registration process required for various services for registered users.

The height adjustment drive unit 28 is fixed as a self-contained module in the base housing 6, for example by means of a screw connection. With respect to the afore-described height adjustment of the support column 4 by means of the electric or electromechanical drive unit 28, it is furthermore easily possible to detect any potential jamming of the support column 4 by means of overload sensors and/or motion sensors, wherein the drive then can be turned off and optionally an alarm device, particularly a flashing light or the like, can be turned on. So as to prevent unauthorized operation during the height adjustment, for example by actuating the up and down control keys without coin insertion etc., it is possible to allow only a defined number of height adjustments following the insertion of money and thereafter block the height adjustment with the control unit 33; renewed actuation of the height adjustment drive unit 28 is then only possible after more money has been inserted and/or following a certain period of time. It is also conceivable, however, to complete block the drive unit 28 or grant complete access. As is the case with the other modules 22, 23, 27, also the drive unit module 28 can be easy to uninstall, for example for repair or maintenance purposes, after removing the side cover. It is preferred if no tools are required to uninstall the different further modules 22, 23, 27. These modules can simply be fixed in place by inserting them in the corresponding holders in the housing 6, optionally with snap-fit locks and the like, as is commonly known.

The money insertion unit 23 may take on various configurations or comprise various components, depending on the requirements, and the components may be interchangeable. Possible insertion units include, for example, coin verification devices, bill readers, but also chip card readers etc. The electronic cash register 27 is preferably disposed such that it is separated from the technical area by an additional lock and can be removed separately.

Due to the laterally unimpaired suspension of the input and output devices (the display unit 2 with the touch screen monitor 9) with the adjustment feature, the user can adjust the device 1 to the respective seating and reach and operate the device 1 unimpaired and without performing gyrations; this is similarly possible for persons in wheelchairs.

As has been mentioned above, the vertical support column 4 and hence the display unit 2 can be adjusted in the vertical direction, preferably from a lower position, for example by 30 cm vertically upward, wherein in the case of a spindle drive 29 as described above or of a comparable drive unit 28 it is preferred if the height adjustment is continuously variable. It is also conceivable to connect the engine control unit 33 to limit switches in order to automatically keep the support column 4 in the lower and upper positions. Limit switches of this type are schematically illustrated in FIGS. 5 and 6 as 41A and 41B. These limit switches 41A, 41B interact with a lateral switch element 42 provided on the spindle motor block 35.

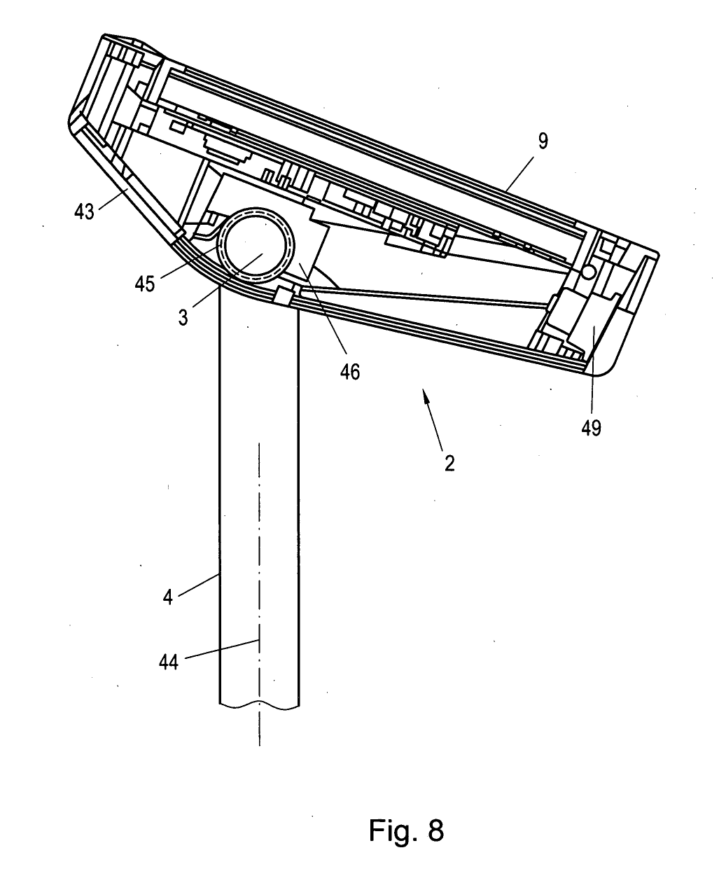

The display unit 2 itself with the housing 43, in which the touch screen monitor 9 is provided, is disposed pivotably directly about the horizontal support arm 3, wherein for example pivoting of the display plane in the range of 10° to 65°, relative to a vertical plane 44 (see the illustrations in FIGS. 7 and 8) is conceivable. Through these adjustment possibilities, the device 1 offers the user the desired operating comfort in any position, be it sitting down or standing up, and for any body size.

As is shown in detail in FIGS. 7 and 8, the horizontal support arm 3 is seated in bearing shells 45 of the display unit 2, with a bracket 46 offering adjustable clamping in the sense of a tight mount of the support arm 3 in the bearing shells 45. The clamping force applied by the bracket 46 can be achieved through locking screws, which are not shown in detail in FIG. 7 and which are used to pull the bracket 46 inside the housing 43 according to FIG. 7 to the left, towards the support arm 3.

So as to exactly define the desired end pivot positions according to FIG. 7 (at an angle of 10° to the vertical plane 44) and/or at 65° to the vertical plane 44 (FIG. 8), stops may be provided in the region of the bearing shells 45 and/or of the support arm 3, which stops are not shown in detail in the drawing; these stops come into contact with each other in sets in the two end positions and prevent further pivoting beyond the two illustrated end positions.

In addition to the monitor (touch screen) 9, the display unit 2 may also comprise a webcam video camera 47 including lighting (see FIG. 7 as well as FIG. 2) and further components, which are only schematically hinted at in FIG. 7, such as a controller 48 and a loudspeaker 49. It is also conceivable to provide a stereo speaker arrangement, see also FIG. 4.

While the detailed drawings and specific examples given herein describe various exemplary embodiments, they serve the purpose of illustration only. It is to be understood that the invention is not limited in its application to the details of construction and the arrangements of components set forth in the preceding description or illustrated in the drawings. Furthermore, other substitutions, modifications, changes, and omissions may be made in the design, operating conditions, and arrangements of the exemplary embodiments without departing from the scope of the invention as expressed in the appended claims.

What is claimed is:

1. A device for reproducing information, comprising:
a vertical support column mounted in a base housing;
an adjustable display unit disposed on the vertical support column in a laterally projecting and height-adjustable manner via a horizontal support arm that is fixedly connected to the support column and projects laterally therefrom;
an input device configured to receive user input; and
a drive unit configured to adjust the height of the support column;
wherein the display unit is configured to tilt about an axis of the support arm.

2. The device of claim 1, wherein the drive unit is configured as a separate module.

3. The device of claim 1, wherein the drive unit comprises a spindle drive.

4. The device of claim 1, wherein the base housing comprises a computer unit.

5. The device of claim 4, wherein the computer unit is configured as a module.

6. The device of claim 1, wherein the base housing comprises a money insertion unit.

7. The device of claim 6, wherein the money insertion unit is configured as a module.

8. The device of claim 1, wherein the base housing comprises at the upper side thereof a table top, which has an opening for the support column.

9. The device of claim 1, wherein the base housing is provided on the bottom thereof with a laterally projecting base plate.

10. The device of claim 9, wherein the base plate comprises a foot rest provided by edging.

11. The device of claim 1, wherein the base housing comprises on a bottom edge thereof at least one rotatably seated roller.

12. The device of claim 1, wherein the display unit comprises a touch screen monitor.

13. The device of claim 1, wherein the display unit comprises an integrated loudspeaker.

14. The device of claim 1, wherein the display unit comprises an integrated imaging unit.

15. The device of claim 14, wherein the integrated imaging unit is a video camera.

16. The device of claim 1, wherein the display unit is configured as a module with an associated controller.

17. The device of claim 1, wherein the display unit is secured on the support arm with the help of a lock.
